(19) United States
(12) Patent Application Publication
(10) Pub. No.: US 2023/0251562 A1
(43) Pub. Date: Aug. 10, 2023

(54) X-RAY HOLDER

(71) Applicant: Rebecca Steffens, Plymouth, MI (US)

(72) Inventor: Rebecca Steffens, Plymouth, MI (US)

(21) Appl. No.: 18/107,280

(22) Filed: Feb. 8, 2023

Related U.S. Application Data
(60) Provisional application No. 63/307,792, filed on Feb. 8, 2022.

(51) Int. Cl. G03B 42/04

(52) U.S. Cl. CPC G03B 42/042

(57) ABSTRACT

A device for holding an x-ray image receptor includes a bracket including a first arm and a second arm and an x-ray image receptor holder rotatably connected to the first arm. The holder includes a base portion with an opening configured to receive a bite piece, and a wall extending from the base portion. The wall is configured to support an x-ray image receptor. The device also includes an alignment ring positioned on the second arm, such that upon rotation of the bracket relative to the holder, a center of the alignment ring corresponds to a center of the holder along the wall. A method of positioning an x-ray image receptor in a patient's mouth is also disclosed.

### CROSS-REFERENCE TO RELATED APPLICATIONS

This application claims priority to U.S. Provisional Application 63/307,792 filed Feb. 8, 2022, which is hereby incorporated by reference herein in its entirety.

### BACKGROUND

This application relates generally to a device for holding an x-ray image receptor, film or digital sensor, in a patient's mouth. Dental and medical professionals often take x-rays of patients' teeth to assess the status, visualize anatomy, document treatment, or to monitor the patient for disease states. However, because the x-ray image receptor is hidden or partially hidden within the patient's mouth, it can be difficult to align the x-ray image receptor and/or x-ray beam so that the resulting x-ray image provides the desired diagnostic value.

### BRIEF DESCRIPTION OF THE DRAWINGS

FIG. 1 schematically shows an example device for holding an x-ray image receptor, film, or digital sensor.

FIG. 2A schematically shows a detail view of and x-ray holder and bite piece of the device of FIG. 1.

FIG. 2B schematically shows another detail view of and x-ray holder and bite piece of the device of FIG. 1.

FIG. 2C schematically shows a detail view of the x-ray holder of FIGS. 1-2B.

FIG. 2D schematically shows another detail view of and x-ray holder and bite piece of the device of FIGS. 1-2C in another position.

FIG. 2E schematically shows another detail view of the x-ray image receptor holder of FIGS. 1-2D.

### SUMMARY

A device for holding an x-ray image receptor according to an exemplary embodiment of this disclosure, among other possible things includes a bracket including a first arm and a second arm and an x-ray image receptor holder rotatably connected to the first arm. The holder includes a base portion with an opening configured to receive a bite piece, and a wall extending from the base portion. The wall is configured to support an x-ray image receptor. The device also includes an alignment ring positioned on the second arm, such that upon rotation of the bracket relative to the holder, a center of the alignment ring corresponds to a center of the holder along the wall.

A method of positioning an x-ray image receptor in a patient's mouth according to an exemplary embodiment of this disclosure, among other possible things includes positioning an x-ray image receptor holder in a patient's mouth. The holder is rotatably connected to a first arm of a bracket. The holder includes a base portion with an opening, a bite portion received in the opening, a wall extending from the base portion, and an x-ray image receptor supported between the wall and the patient's teeth.

### DETAILED DESCRIPTION

X-rays are one way to visualize a patient's teeth and underlying bone during various treatments and for monitoring the patient's oral health, which is important to early identification of certain disease states. Dental x-rays are typically taken by first placing an x-ray image receptor, such as film or digital sensor, in the patient's mouth, next aligning the x-ray beam outside the patient's mouth, and then capturing the x-ray image. However, after placing the image receptor in the patient's mouth, it becomes hidden or partially hidden and may in some cases shift after its initial placement. Therefore, it can be difficult to align the x-ray image receptor and/or x-ray beam to capture the desired visualization of the patient's teeth and/or underlying bone. Often multiple x-ray images must be taken in order to obtain the desired visualization, which can interfere with the patient's comfort, increase radiation exposure, and add to the procedure time. Additionally, during certain dental procedures, devices such as dental dam isolation are arranged in the patient's mouth, and those devices may need to be removed to situate the x-ray image receptor and then replaced afterwards, which also adds to procedure time and reduces asepsis.

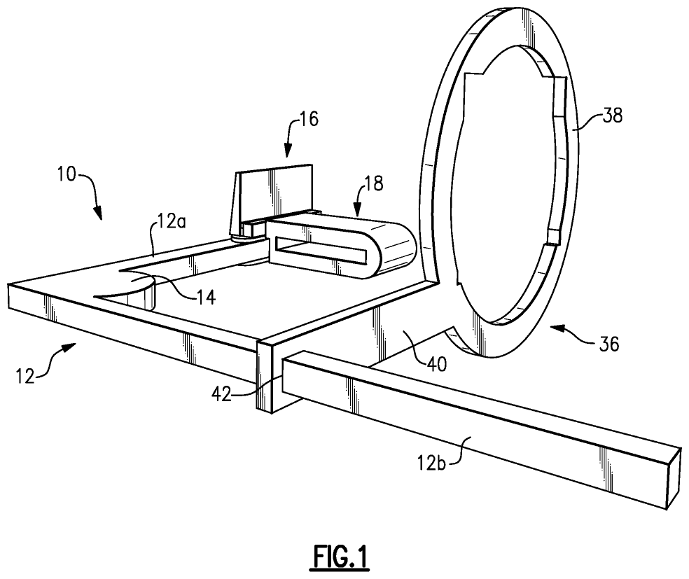

FIG. 1 shows a device 10 for holding an x-ray image receptor, film or digital sensor. The device 10 includes an L-shaped bracket 12 that has two arms 12a/12b arranged generally perpendicular to one another. The bracket 12 may include a support 14 at the meeting point of the two arms 12a/12b, which provides stability and can act as a handle for the patient to hold when necessary. The arms 12a/12b meet at respective first ends. The first arm 12a has a second end opposed from the first end that is removably connected to an -ray image receptor holder 16. The -ray image receptor holder 16 is configured to receive an x-ray image receptor such as film or a digital sensor positioned for periapical x-rays.

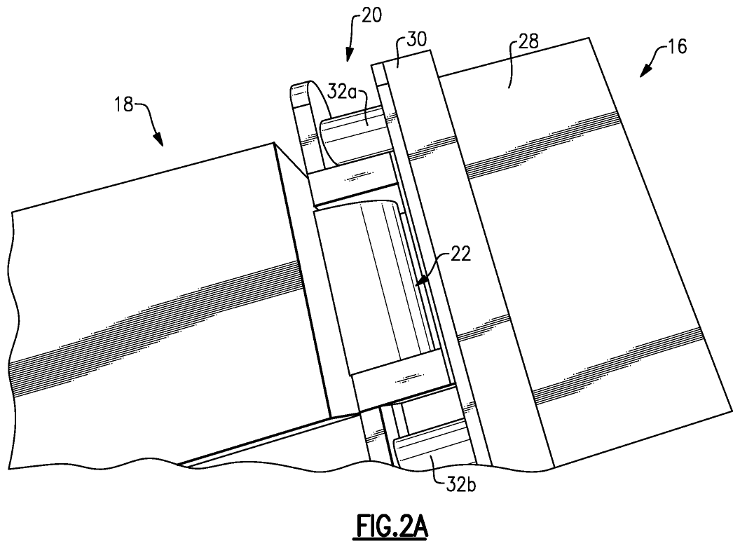

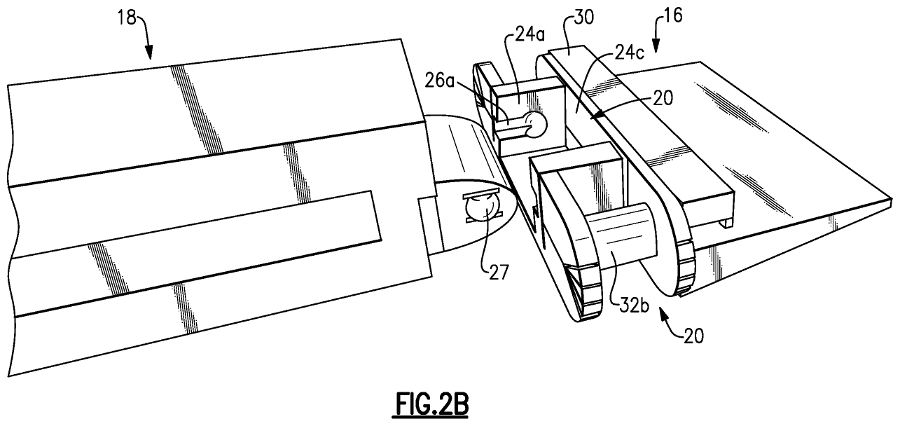

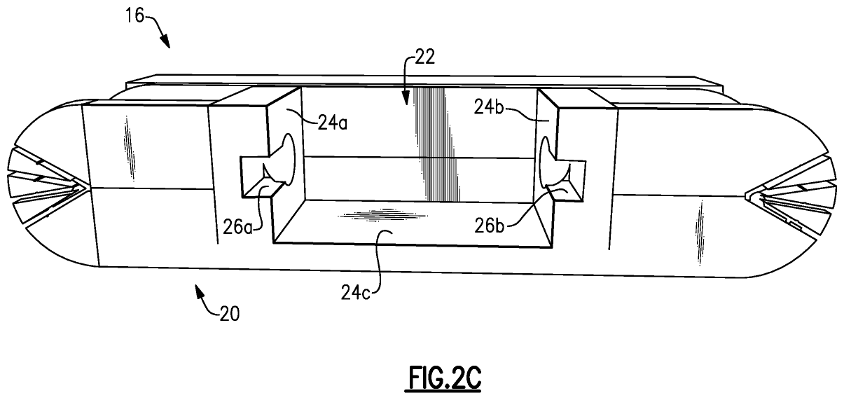

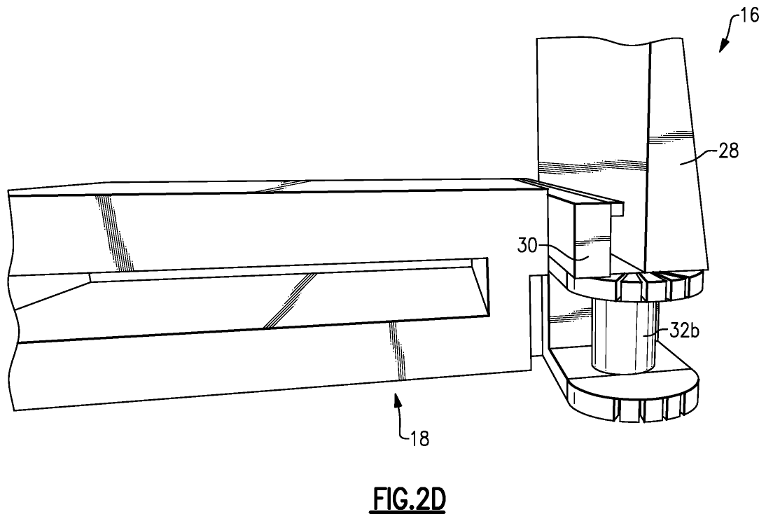

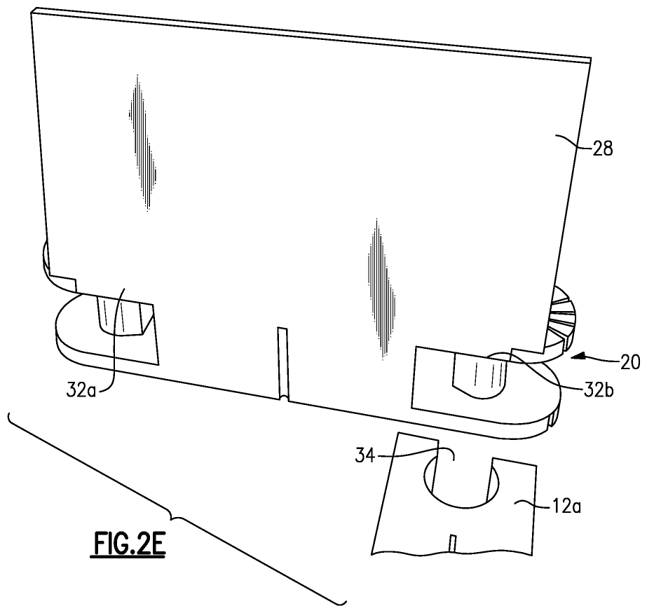

FIGS. 2A-E show detailed views of the -ray image receptor holder 16. The holder 16 includes a base portion 20 with an opening 22 configured to receive the bite piece 18. As best shown in FIGS. 2A-B, the opening 22 is defined by three side walls. Two of the side walls 24a/24b are opposed from one another, and the third side wall 24c joins the opposed side walls 24a/24b. Thus, the bite piece 18 can be received between the side walls 24a/24b and abuts the third side wall 24c when installed in the holder 16.

In some examples, the opening 22 includes an engagement feature 26 for engaging the bite piece 18 and retaining it in the opening 22. In this example, the engagement feature 26 includes slots 26a/26b formed in the side walls 24a/24b. The slots are configured to receive tabs 27 on the bite piece 18. The engagement feature 26 may allow for relative rotation of the holder 16 when it is engaged with the bite piece 18. For instance, the holder 16 may rotate with respect to the bite piece 18 between a first position where it is generally parallel to an orientation of the bite piece 18 as in FIG. 2A, a second position where it is generally perpendicular to the orientation of the bite piece 18 as in FIG. 2D, and any position in between the first and second positions. This flexibility improves patient comfort because it allows for accommodation of various mouth sizes, and it allows for the patient's anatomy to guide the positioning of the holder 16, while the bite piece 18 remains fixed between the occluding teeth. In general, x-rays are taken when the holder 16 is at or near the second position.

Extending from the base portion 20 is a wall 28. The wall 28 provides support for the x-ray image receptor (e.g., the film or digital sensor), and is configured to be placed on the medial side or inside of the patient's teeth such that the bite piece 18 extends between the occluding teeth. The wall 28 may be tapered, as best seen in FIG. 2B, with the thickness decreasing from the end closest to the base 20 to the distal end. This tapered design improves patient comfort when taking periapical x-rays of lower teeth and allows accommodation of the tongue and floor of the mouth. The wall 28 may include a support 30 configured to stabilize an x-ray image receptor such as film in the appropriate position relative to the bite piece 18 when it is in the second position. In this example, the x-ray image receptor is supported between the wall 28, and more particularly the support 30, and the patient's teeth. In another example, double-sided tape or another suitable adhesive may be used to temporarily connect an x-ray image receptor such as a digital receptor to the wall 28.

The holder 16 includes a connector 32 for connecting to the first arm 12a. As best seen in FIG. 2E, in one example, the connector 32 includes two columns 32a/32b on either side of the base 20, flanking the opening 22. Though the columns 32a/32b are shown as having a circular cross-section, other geometries are contemplated. The first arm 12a includes an opening 34 that has a profile configured to mate with one of the columns 32a/32b, depending on the desired orientation of the holder 16 with respect to the first arm 12a. For instance, the column 32a/32b may be selected based on which quadrant of the patient's mouth will be x-rayed. The opening 34 is configured to removably mate with the specific geometry of the columns 32a/32b, then once engaged, rotate around an axis of the columns 32a/32b. This allows periapical x-rays at known horizontal angulations in order to increase diagnostic value of x-ray images.

Turning again to FIG. 1, the device also includes an alignment ring 36. The alignment ring 36 includes a ring portion 38 and a stem portion 40. The ring portion 38 is configured to receive the tube head of an x-ray machine that is oriented near the patient's mouth. The stem portion 40 includes an opening 42, which is configured to slidably receive the second arm 12b to adjust the x-ray beam distance to the image receptor.

The alignment ring 36 is positioned on the arm 12b, and due to the fixed nature of the arms 12a/12b relative to one another, and the rotation of the arms 12a/12b relative to the holder 16, the center of the alignment ring 36 corresponds to the center of the holder 16 along the wall 28. In other words, certain positions of the alignment ring 36 indicate a corresponding x-ray beam angulation, while the holder 16 remains stable in the patient's mouth via the bite piece 18. Accordingly, because the alignment ring 36 remains outside of the patient's mouth, it serves as an indicator for the positioning of the x-ray tube head to remain center and perpendicular to the holder 16 and x-ray image receptor held therein. This decreases x-ray image distortion and/or error and increases the diagnostic value of the x-ray images. Moreover, when the bite piece 18 is detached, the alignment ring 36 and arms 12a/12b with support 14 allow for positioning and stabilization of the holder 16 in the patient's mouth, even when devices such as dental dam isolation are in the patient's mouth. That is, the assembly can be used even without the bite piece 18 when needed.

In some examples, arm 12a and/or the base 20 may include markings that indicate certain angulations/positions of the x-ray beam (via the alignment right 36) with respect to the bite piece 18.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A device for holding an x-ray image receptor, comprising:
a bracket including a first arm and a second arm;
an x-ray image receptor holder rotatably connected to the first arm, the holder including a base portion with an opening configured to receive a bite piece, and a wall extending from the base portion, the wall configured to support an x-ray image receptor; and
an alignment ring positioned on the second arm, such that upon rotation of the bracket relative to the holder, a center of the alignment ring corresponds to a center of the holder along the wall.

2. The device of claim 1, wherein the opening includes an engagement feature configured to engage the bite piece.

3. The device of claim 1, wherein the holder and bite piece are rotatable with respect to one another.

4. The device of claim 3, wherein in a first position the holder is generally parallel to the bite piece, and in a second position the holder is generally perpendicular to the bite piece.

5. The device of claim 1, wherein the wall has a decreasing thickness from the base portion.

6. The device of claim 1, wherein the wall includes a support configured to stabilize an x-ray image receptor relative to the bite piece.

7. The device of claim 1, wherein the holder includes first and second columns on either side of the base, the opening defined between the first and second columns, and wherein the first arm includes an opening configured to mate at least one of the first and second columns.

8. The device of claim 1, wherein the alignment ring is configured to receive a tube head of an x-ray machine.

9. The device of claim 1, wherein the alignment is includes a stem portion with an opening, and wherein the opening of the stem portion is configured to slidably receive the second arm therein.

10. The device of claim 1, wherein at least one of the first arm and the base portion include markings that correspond to certain angulations or positions for the holder.

11. The device of claim 1, wherein the x-ray image receptor is film or a digital sensor.

12. A method of positioning an x-ray image receptor in a patient's mouth, comprising:
positioning an x-ray image receptor holder in a patient's mouth, wherein the holder is rotatably connected to a first arm of a bracket and wherein the holder includes a base portion with an opening, a bite portion received in the opening, a wall extending from the base portion, and an x-ray image receptor supported between the wall and the patient's teeth.

13. The method of claim 12, wherein the bracket includes a second arm and an alignment ring positioned on the second arm, and further comprising placing a tube head of an x-ray machine in the alignment ring.

14. The method of claim 13, further comprising rotating the first and second arms relative to the holder such that a center of the alignment ring corresponds to a center of the holder along the wall.

15. The method of claim 13, wherein at least one of the first arm and the base portion include markings that correspond to certain angulations or positions for the holder, and further comprising adjusting the tube head of the x-ray machine based on the markings.

16. The method of claim 12, further comprising rotating the holder with respect to the bite piece or the bite piece with respect to the holder to position the bite piece and holder with respect to the patient's teeth.

17. The method of claim 12, wherein the wall has a decreasing thickness from the base portion.

18. The method of claim 12, wherein the wall includes a support configured to stabilize the x-ray image receptor relative to the bite piece.

19. The method of claim 12, wherein the holder includes first and second columns on either side of the base, the opening defined between the first and second columns, and wherein the first arm includes an opening configured to mate at least one of the first and second columns.

20. The method of claim 12, wherein the x-ray image receptor is film or a digital sensor.
